(19) United States
(12) Patent Application Publication
(10) Pub. No.: US 2017/0145528 A1
(43) Pub. Date: May 25, 2017

(54) High Strength Iron-Based Alloys, Processes for Making Same, and Articles Resulting Therefrom

(71) Applicant: Gary M. COLA, JR., Washington, MI (US)

(72) Inventor: Gary M. COLA, JR., Washington, MI (US)

(21) Appl. No.: 15/319,710

(22) PCT Filed: Jun. 7, 2015
(86) PCT No.: PCT/US2015/036313

§ 371 Date: Dec. 16, 2016

Related U.S. Application Data
(60) Provisional application No. 62/100,373, filed on Jan. 6, 2015.
(60) Provisional application No. 62/093,731, filed on Dec. 18, 2014.
(60) Provisional application No. 62/013,396, filed on Jun. 17, 2014.

(51) Int. Cl. C21D 1/42; C21D 1/32

(52) U.S. Cl. CPC C21D 1/42; C21D 1/32; C21D 2211/001; C21D 2211/008

(57) ABSTRACT

A new iron based alloy prepared by extremely rapid heating followed substantially immediately by extremely rapid cooling. Methods and materials made by optionally initially spheroidized annealing of raw iron based alloys into a precursor material are disclosed. After optional spheroidized annealing, the precursor material is rapidly heated to a temperature above the austenitizing temperature of the material and rapidly cooled to yield a high strength iron based alloy. Methods and materials for realizing a corrosion resistant high strength iron based alloy are disclosed, as are methods, materials and articles which exhibit the ability to form bend radii of nearly folding over itself.

### CROSS-REFERENCE TO RELATED APPLICATIONS

This application claims the benefit of priority of the following Provisional Patent Applications: Appln. No. 62/013,396, filed Jun. 17, 2014, Appln. No. 62/093,731, filed Dec. 18, 2014 and Appln. No. 62/100,373, filed Jan. 6, 2015.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED, INCLUDING ON A COMPACT DISC

U.S. patent application Ser. No. 14/404,007, filed Nov. 25, 2014

U.S. Pat. No. 8,480,824 B2, Issued Jul. 9, 2013

U.S. patent application Ser. No. 12/485,785, filed Jun. 16, 2009

U.S. patent application Ser. No. 12/444,242, filed Apr. 3, 2009

### TECHNICAL FIELD

This invention relates to advanced high strength iron-based alloys, and more particularly relates to processes for transforming and/or shaping the same. Such alloys are capable of being formed to minimal bend radii and can be obtained by treating low, medium, and high carbon steel. Such iron based alloys can also be designed to be corrosion resistant by phosphoric alloying while avoiding grain boundary embrittlement.

### BACKGROUND OF THE INVENTION

Traditionally, metallurgists have wanted to take low quality metals, such as low carbon steel, and turn them into high quality steels and more desirable products through inexpensive treatments, including annealing, quenching, and tempering to name a few. Previous attempts have met with limited success in that they did not always produce a desirable product. Other attempts have failed on a large scale due to high processing costs or the need to ultimately incorporate excessive, expensive alloying.

Generally, the rule with steel is that the stronger steel gets, the harder it is, but the less elongation the steel will have. In most instances, the word “elongation” is used synonymously with the terms ductility, bendability, or formability. Elongation is tested in a tensile test stand which uniaxially pulls the steel sample apart to determine just how much the steel will elongate, or stretch, before failure. ASTM has a lengthy review of tensile testing.

As steel becomes harder, and has less elongation or ductility, its ability to be formed into shapes in a stamping press forming die is reduced. The steel industry has gone to great lengths focusing on increasing strength while trying to maintain or increase elongation. This is done at a significant cost penalty through the use of capitally intensive thermomechanical processes which take many minutes to homogenize, quench, then temper the steel. As well, alloying elements are added at further cost penalty in order to increase the strength, and more importantly, the elongation of the steel.

The steel industry advertises their products' strength and elongation as guaranteed minimum performance. The United States automotive industry typically uses a standard 50 mm gage length as spelled out by ASTM. The ASTM promulgates standards that have been developed such that steels with 15% elongation will stretch at least 15% before failure and it is known by those skilled in the art that such a steel could be folded over onto itself as if folding a sheet of paper onto itself. This would be considered a “zero-T” bend with “T” representing the thickness of the material relative to the bend radius. Another rule of thumb is that steels with only 10-12% elongation typically can be formed to a bending radius between one to two material thickness (e.g. a 1T bend to a 2T bend). Widely known as well is that steels with 7-9% elongation require at least a 2T to 3T bending radius and more often 3T to 5T bending radius when forming parts in a stamping press to prevent the steel from cracking.

Processing of advanced high strength steel to make highly formable steel generally takes intense capital equipment, high expenditures, expensive and dangerous heated fluids, such as quenching oils and quenching salts, and tempering/annealing processes which include the use of furnaces, heated equipment, and residual heat from pouring molten steel. These quenching procedures are intended to raise the hardness of the steel to a desirable value. Bainite and martensite can be made by these processes and are very desirable materials for certain high strength applications as they generally have Rockwell C hardness from about 20 and up. The increased hardness correlates to a comparable increase in tensile strength.

Typical advanced high strength steels have generally included bainitic and/or martensitic phases. Multiple phase materials include a number of different co-existing microstructures, including bainite, martensite, acicular ferrite and other morphologies of ferrite, retained austenite, pearlite, and/or others. Bainite is generally acicular steel structured of a combination of ferrite and carbide that exhibits considerable toughness while combining high strength with good ductility. Historically, bainite has been a very desirable product commercially made by traditional austempering through a rather lengthy thermal cycling, typically taking at least more than several minutes to hours. One practical advantage of bainitic steels is that relatively high strength levels can be obtained together with adequate ductility without further heat treatment after the bainite transformation has taken place.

Such bainite containing steels, when made as a low carbon alloy, are readily weldable. Conventional bainite made through these lengthy processes has been found to be temper resistant and is capable of being transformed and/or remain in a heat-affected zone adjacent to a welded metal, thereby reducing the incidence of cracking and providing for a less brittle weld seam. Furthermore, these conventional bainitic steels have a lower carbon content as they tend to improve the overall weldability and experience reduced stresses arising from transformation. When locally heterogeneous chemistry exists, weldability is further increased due to the presence of lower carbon regions. When austempered bainite is formed in medium and high carbon steels that have significant alloying elements added, weldability is reduced due to the higher carbon equivalence content in each of the chemistry homogenized grains of steel.

The other typical conventional high strength steel constituent, martensite, is another acicular microstructure made of a hard, supersaturated solid solution of carbon in a body-centered tetragonal lattice of iron. It is generally a metastable transitional structure formed during a phase transformation called a martensitic transformation or shear transformation in which larger workpieces of austenized steel may be quenched to a temperature within the martensite transformation range and held at that temperature to attain equalized temperature throughout before cooling to room temperature. Martensite in thinner sections is often quenched in water. Since chemical processes accelerate at higher temperatures, martensite is easily tempered to a much lower strength by the application of heat. Since quenching can be difficult to control, most steels are quenched to produce an overabundance of martensite, and then tempered to gradually reduce its strength until the right hardness/ductility microstructure exists for the intended application is achieved.

The high strength steel industry is looking for a less expensive method to achieve these high strength steels. Further, the steel industry wants to inexpensively produce steels, including both single, complex and multi-phase materials, that are capable of minimal bend radius forming, as well as a more corrosion resistant high strength steel.

### SUMMARY OF THE INVENTION

In accordance with the present invention, low grade ferrous alloys in strips, sheets, bars, plates, wires, tubes, profiles, workpieces and the like are converted into multi-phase, multi chemistry advanced high strength steels that exhibit a high bend-ability to minimal forming radii with a reasonable elongation value to be produced with a minimum of cost, time and effort. In particular, plain carbon steel can be made into single phase or multi-phase materials that are extremely formable, even zero-T bend radius capable, yet have strengths in excess of 900 megapascals. Articles with bend radii as small as one material thickness or less made from these dual and complex phase materials are achievable by practicing the present invention. Due to the short duration of the heating of the iron based alloy from the lower austenization temperature to the peak selected temperature followed promptly by cooling, this method has become known as “Flash® Processing”. Using various minimally alloyed steels, having found the ability to rapidly achieve a partially bainitic microstructure, this method has become known as “Flash® Processing”.

A method for rapidly micro-treating an iron-based alloy is disclosed for forming at least one phase of a high strength alloy, where the method comprises the steps of providing an iron-based alloy having a first microstructure with an austenite conversion temperature. This first microstructure is capable of being transformed to an iron-based alloy having a second microstructure including the above mentioned phases by rapidly heating at an extremely high rate, such as 100° F./sec to 5000° F./sec from below the lower austenitic conversion temperature, up to a selected peak temperature above the austenitic conversion temperature. Upon cooling, this second microstructure is known to be heterogeneous due to the minimal time allowed (<10 s above the austenization temperature) for homogenization of alloying elements in the initial carbide containing iron based alloy. Cooling rates up to 5000° F./sec have been found to stabilize the chemical and microstructural heterogeneity. Preheating, up to 750° C., has been found beneficial provided that the preheat temperature achieved is low enough to avoid accelerating carbon leveling, carbide dissolution, and alloy homogenization.

In the practice of the present invention, traditionally calculated bulk chemistry austenitic conversion temperatures are elevated for given alloys due to the short duration of the thermal cycle initiated by the rapid heating. This elevated austenization temperature, which occurs for less than 10 sec, is in part due to an averaging of austenization temperatures of the multiple alloy concentrations and alloy enriched carbides present within the steel in the individual austenite grains. Because different carbon concentrations have different upper austenization temperatures, the carbon concentration, or lack thereof, present in the majority of the prior austenite grains will have the greatest influence on the iron based alloy instantaneous austenization temperature. For example, an iron based alloy comprised primarily of ferrite, which contains very low carbon concentration, would have a relatively high upper instantaneous austenization temperature closest to that of ferrite in pure iron.

By thermally cycling a plain carbon steel from room temperature to an elevated temperature above the austenitic temperature of the steel within 10 seconds from below the lower austenization temperature and then quenching it within less than 10 seconds from achieving the selected peak temperature, to below the martensitic finish temperature of the chemistries present, the entire cycle being less than 20 seconds, a formable steel is produced that can achieve a minimal bend radius of previously unseen strength with an elongation of only about 5 to 12 percent. Optimally, the steel can be bent back on itself 180°, also known as “zero-T” bend with the “T” referring to the material thickness or to a 1T bend radius.

This extremely rapid heat and extremely rapid quench sequence occurs without any substantial holding period at the elevated temperature, less than 10 sec. The quench occurs at an extremely fast rate, i.e. 100° F./sec to 5,000° F./sec on at least a portion of the iron-based alloy in a quenching unit that is immediately adjacent the heating unit. By the term “immediately adjacent”, we mean that the quench occurs within centimeters or a meter, and the transfer is nearly instantaneous. In some instances, slower or interrupted quenching is desired to enact continuous cooling transformation or time temperature transformation of the carbide containing iron based alloy. This procedure forms at least one phase of a high strength alloy in a desired area, depending upon where the treatment was performed on the iron based alloy.

Quenching may be accomplished nearly instantaneously, i.e. within less than 10 seconds by various methods and apparatuses. Such equipment for quenching includes water baths, water sprays, chilled forming dies, air knives, open air convection, final operation chilled progressive dies, final stage chilled line dies, chilled roll forming dies, and quenching hydroforms among others. Slower or interrupted cooling is possible through the use of molten salts, oils, steam, heated gaseous solutions, chilled quenching rollers, and many other means known to those skilled in the art. Regardless of quenching method, initiation of quenching is to occur substantially immediately, within 10 seconds, without any substantial holding period, after reaching the peak selected heating temperature limiting carbon migration, carbide dissolution, and alloy homogenization.

Through optimization of the first microstructure, conditions can be established that will aid in maintaining intra grain chemical heterogeneity in the alloy. Processes such as spheroidize annealing of the steel will create carbides which limit carbon migration. Annealing treatments which cycle above and below the lower austenization temperature have been found to create precipitated austenite near the grain boundary perimeter. While spheroidize annealing typically requires many hours to days in furnaces, a novel continuous processing method is proposed requiring less than an hour to accomplish. Since austenite has higher solubility for carbon and manganese, the carbon and manganese will enrich the precipitated austenite while migrating from the grain central region provided the upper austenization temperature is not exceeded. In proper localized concentrations of carbon and manganese, which can be determined by continuous cooling transformation diagrams, the precipitated austenite will remain upon cooling. Such precipitated austenite will also remain after Flash® Processing to become retained austenite. In some instances during Flash® Processing, carbides dissolve to provide additional carbon near the manganese enriched regions creating more retained austenite upon cooling.

Additions of up to 2% by weight of phosphorus based on the overall weight of the iron based alloy have been found to create corrosion resistant properties in the iron alloy article without causing grain boundary embrittlement. Such performance is achieved when phosphorus has migrated to a grain central region within individual prior formed austenite grains resident within the iron based alloy. Such chemical heterogeneity is developed during annealing treatments which cycle above and below the lower austenization temperature as the phosphorus migrates away from the carbon enriched grain perimeter of precipitated austenite.

All discussions herein include recitations of various weight percentages, and for purposes of this application, all weight percentages shall be assumed to be based on the total weight of the iron based alloy that incorporate the weight percentage, whether it is stated or not.

Rapid cycling to temperatures above and then quickly below the lower austenization temperature is a novel aspect of this invention to create grain boundary precipitated austenite. Simply holding the iron based alloy between the lower and upper austenization temperatures will create individual “blocky” grains of precipitated austenite which in turn create individual grains more enriched with carbon. If only random individual grains become enriched with carbon, instead of a significant majority of grains having perimeter carbon enrichment, the remaining grains in the iron based alloy could have undesired grain boundary phosphorus. The grain central phosphorus enriched iron based alloy has commercial uses both as a Flash® Processed article as well as in the prior non-Flash® Processed condition. The strength in a non-Flash® Processed article will be lower but will still be corrosion resistant for uses such as architectural sections.

Therefore, the description below will describe processes for making these new high strength alloys, articles made therefrom and the alloys themselves.

### BRIEF DESCRIPTION OF THE DRAWINGS

For a further understanding of the nature and advantages of the expected scope and various aspects of the present invention, reference shall be made to the following detailed description, and when taken in conjunction with the accompanying drawings, in which like parts are given the same reference numerals, and wherein:

FIG. 1A is a FEGSEM micrograph of an iron based alloy processed in accordance with Flash® Processing;

FIG. 1B is a FEGSEM micrograph of an iron based alloy processed in accordance with Flash® Processing;

FIG. 2A is a graph of typical temperature measurements at an inside wall of Flash® Processed tube;

FIG. 2B is a heating/cooling cycle time/temperature graph of the process in accordance with the present invention;

FIG. 2C is a heating and cooling cycle simulating austenite grain development over time;

FIG. 3 is a transformation analysis graph of temperature versus differential of temperature showing dual transformation cooling in which two different chemistries of alloy are quenched within the bulk alloy;

FIG. 4 is a chemical depiction of an individual grain of an iron based alloy to create retained austenite;

FIG. 5 is a chemical depiction of an individual grain of iron based alloy to create a corrosion resistant iron alloy that could become a Flash® Processed article;

FIG. 6 is a photograph of a 1550 megapascal workpiece formed in accordance with the present invention;

FIG. 7 is a photograph of a 1550 megapascal cold formed stamping;

FIG. 8 is a photograph of a 1550 megapascal workpiece used in the automotive industry;

FIG. 9 is a photograph of another 1550 megapascal cold formed stamping;

FIG. 10 illustrates an angular formed metal stamping, showing a lack of failure;

FIG. 11 is a photograph of yet another cold formed stamping without failure;

FIG. 12 is a photograph of a cold stamped B-pillar part on a laser bed trimming off excess;

FIG. 13 is a photograph of a mock-up of an induction heating coil illustrating 6 legs of parallel, uni-directional current flow with 3 legs on each side of a steel strip;

FIG. 14 is a photograph of grid etched then room temperature stamped parts of Flash® 1500;

FIG. 15 is a photomicrograph of enlarged prior austenite grains of Flash® Processed steel; and

FIG. 16 is a depiction of continuous rolling equipment that uses induction heating to spheroidize anneal iron based alloy.

### DETAILED DESCRIPTION OF THE DRAWINGS

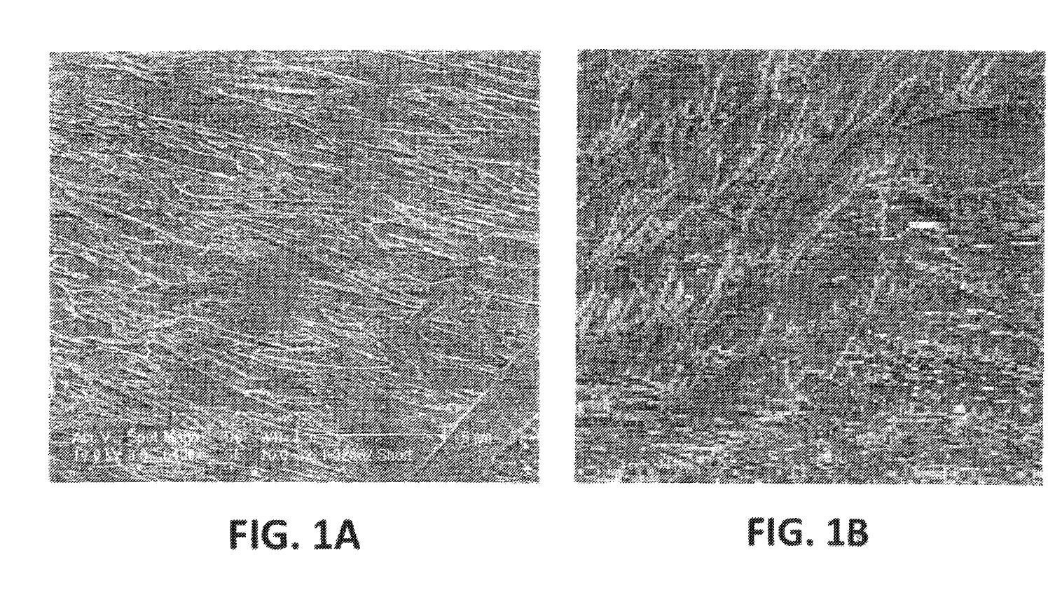

Looking first with combined reference to FIGS. 1A and 1B, there can be seen that the Flash® processed steel includes a bi-modal size distribution of bainitic platelets or plates which exhibit highly desirable combinations of strength, ductility and toughness. The Flash® processing of the present invention can create almost distortion free flat sheets, bars, plates and straight tubing. As can be seen in these Figures, the microstructure produces a fine grain structure within the bi-modal distribution of microstructures which yields the surprising strength and ductility.

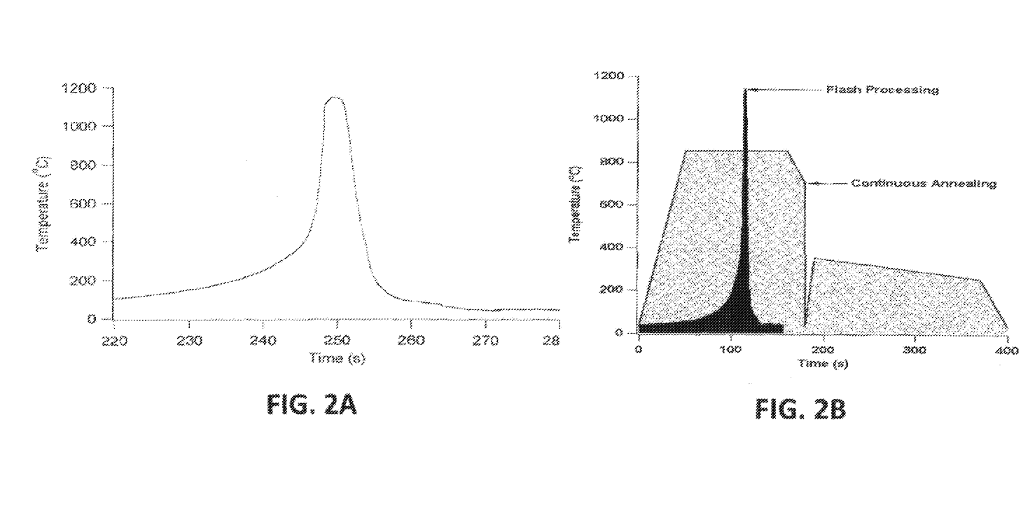

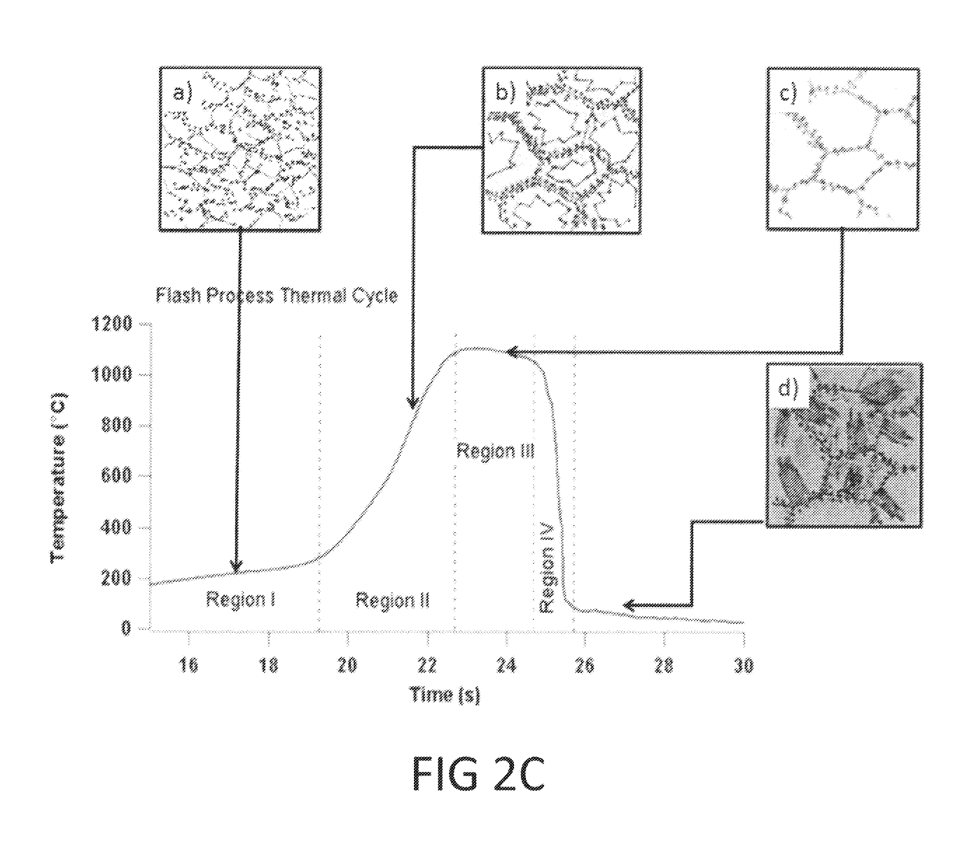

With reference to FIG. 2A, a graph is shown charting temperature in degrees ° C. versus time in seconds to illustrate the heating and cooling cycle at the inside wall of a tube as it is Flash® Processed. Typical temperature measurements of this inside wall are showing that there is a very low temperature-time history ratio.

Looking now to FIG. 2B, there is shown a graph of temperature versus time showing the Flash® processing temperature to time history ratio in addition to the conventional steel industry continuous annealing line temperature to time history. Clearly, the temperature to time history ratio for the continuous annealing line is much greater than that ratio for the Flash® processing.

FIG. 2C illustrates the austenite growth during the Flash® Processing thermal cycle. Region I shows prior austenite grains. Region II shows austenite growth starting at the grain boundary. Region III shows heterogeneous austenite grains in which carbon leveling and full carbide dissolution has not occurred. Region IV shows a complex mixture of bainite and martensite within the same prior austenite grains.

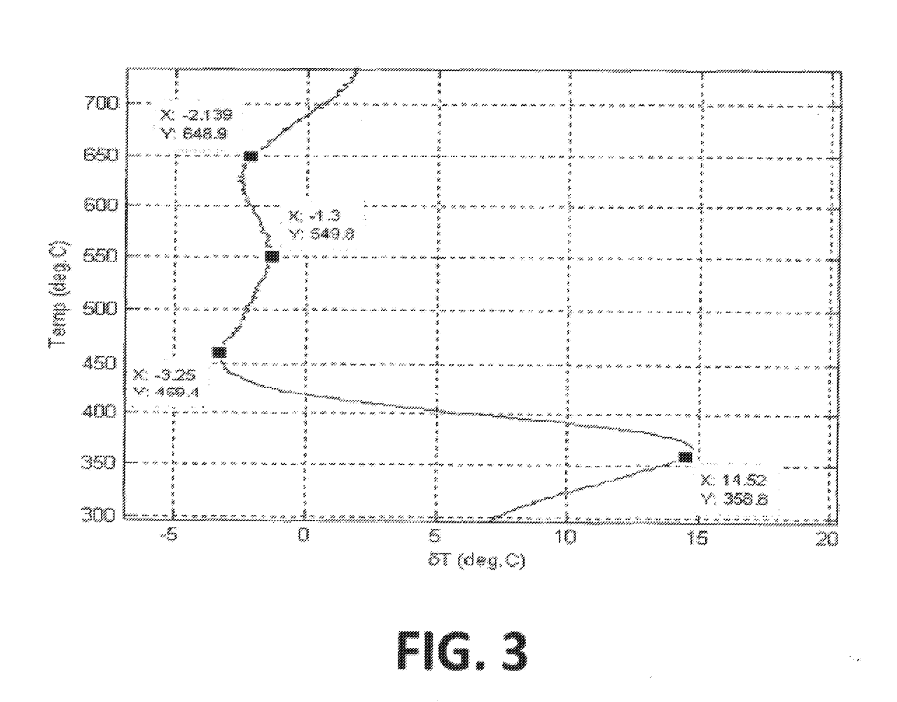

FIG. 3 illustrates an analysis of temperature in degrees centigrade versus the change in temperature also in degrees centigrade. This analysis shows intense transformations to austenite daughter phases at between 650 and 550 degrees C. and 460 to 360 degrees C. during cooling. This analysis suggests that we have two different transformation conditions leading to very localized microstructural heterogeneity, although experiencing homogeneity on a macro scale. The two different transformation temperature ranges are present due to the heterogeneous localized chemistry in the AISI4130 alloy as it is quenched. Other iron based alloys will have different temperature ranges but will exhibit the same dual transformation cooling characteristics. Depending on alloy and carbon heterogeneity, each transformation is likely a multiplicity of different chemistry transformations occurring at approximately the same location. This is occurring because of the presence of localized regions of prior ferrite that might have enriched to either 0.05, 0.08, or 0.10 weight percent carbon based on the total weight. Each different carbon prior austenite grain will have its own transformation start and finish temperature but will overlap on a graph of this nature.

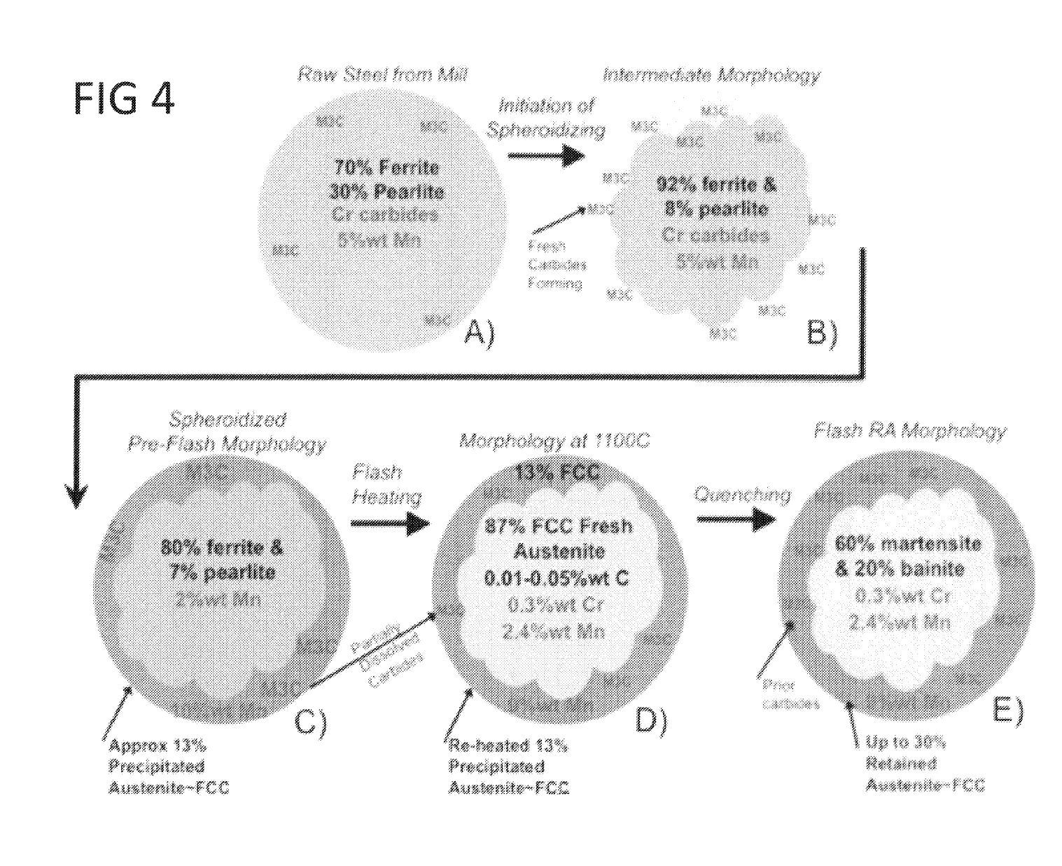

FIG. 4 is a chemical depiction of an individual grain of iron based alloy to create retained austenite. The illustration depicts how repeated thermal cycling above and below the lower critical austenite conversion temperature can enrich the grain boundary region of precipitated austenite with carbon and manganese. This occurs because austenite has a higher solubility for both carbon and manganese than does ferrite. Such enrichment will allow precipitated austenite to become stable as retained austenite at room temperature, even after Flash® Processing. Proposed elemental concentrations and volume fractions are provided but are only an example of many possibilities based on bulk chemistry present in the iron based alloy.

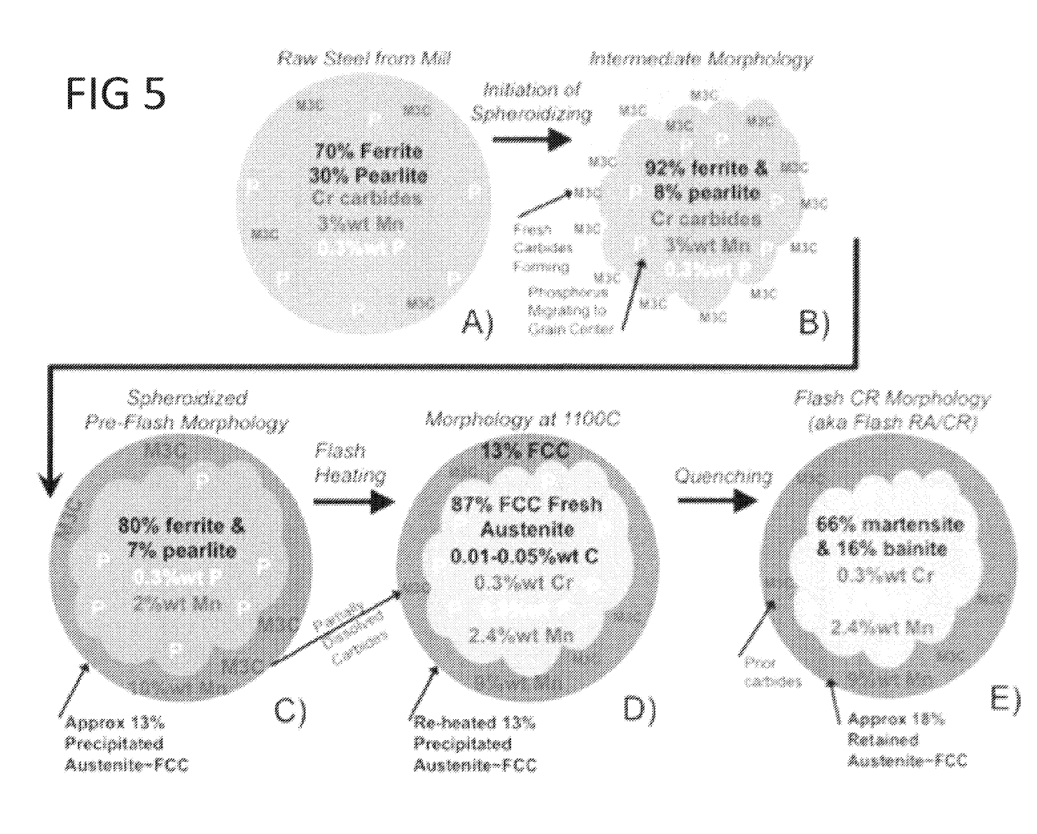

FIG. 5 is a chemical depiction of an individual grain of iron based alloy to create a corrosion resistant iron alloy that could become a Flash® Processed article. The illustration depicts how repeated thermal cycling above and below the lower critical austenite conversion temperature can enrich the grain boundary region of precipitate austenite with carbon and potentially manganese. This occurs because austenite has a higher solubility for both carbon and manganese than does ferrite. During this process, grain central regions of ferrite will become depleted of both carbon and manganese. It is well understood by those skilled in the art that carbon and phosphorus prefer to not co-locate. As the carbon moves toward the grain boundary, the phosphorus will move to the grain interior. This product with centralized intra granular enrichment of phosphorus is useful in both the pre-Flash® Processed condition and the Flash® Processed condition. Proposed elemental concentrations and volume fractions are provided. It should be noted that manganese is not essential to make corrosion resistant iron alloy and its presence, or lack of, will only affect the volume fraction of retained austenite in the final product. For uses such as architectural sections relying on strength with minimal deflection needed, retained austenite might not be as desirable. However, in articles such as formed automotive components, retained austenite due to the presence of manganese could be beneficial.

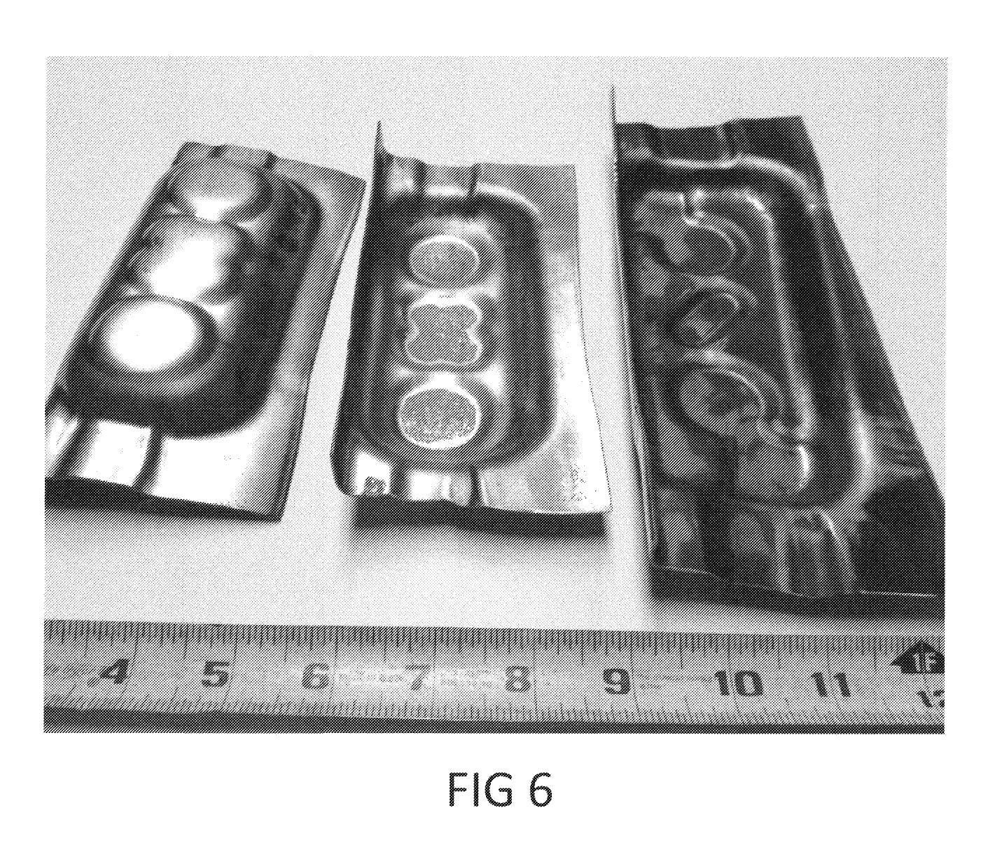

FIG. 6 shows a workpiece, commonly called a “bathtub” automotive part, formed by the methods of the present invention, and as one can note, there are no failures to be observed at the nearly 90° turns in the piece. In the case of Flash® Processed AISI1020 steel, strengths of 1400-1600 MPa, A50 elongation of 6 to 10%, and a Rockwell C hardness of 44 to 48 has been achieved. It is widely accepted since the 1920's that thinner steel sheet will trend toward lower total elongation in tensile testing. However, we did find that Flash® processed AISI1020 at 3 mm thick has a total elongation of 9-10%. As such, one would expect a minimum bend radius of two-T before crack initiation and failure. Unexpectedly, 1.2 mm thick sheet of Flash® processed AISI1020 at only 6 to 6.5% elongation has been able to be bent to a 0T bend radius, essentially folding over on itself. Additionally, 1.9 mm thick sheet Flash® Processed AISI1010 steel at only 7-8% elongation and Rockwell C hardness measured between 30 and 34 has been able to be bent between a 0T and 1T bend radius. According to the ASTM Rules of Thumb based on elongation of steel, neither of these latter two would be expected to occur without cracking, but steel produced by Flash® Processing achieved this goal with ease.

This “bathtub” shaped part was cold stamped, which is a critical method desired by the automotive manufacturers. Cold stamping steels with strength of 1500 megapascals is desirable because all the additional steps of “hot stamping” of costly boron steels are alleviated, thereby reducing manufacturing costs by approximately one half. The results of these experiments achieved some unexpectedly good results using common plain carbon steels which have very minimal alloy content compared to other advanced high strength steels. Plain carbon steel is called out as AISI10##, with the “##” representing the percent weight carbon contained in the steel. For example, AISI1020 steel would contain approximately 0.20% wt carbon. When such steels are rapidly heated to over 1000° C. and subsequently quenched without a prolonged holding period, as described in this inventor's previously issued U.S. Pat. No. 8,480,824, highly unexpected and desirable results were obtained.

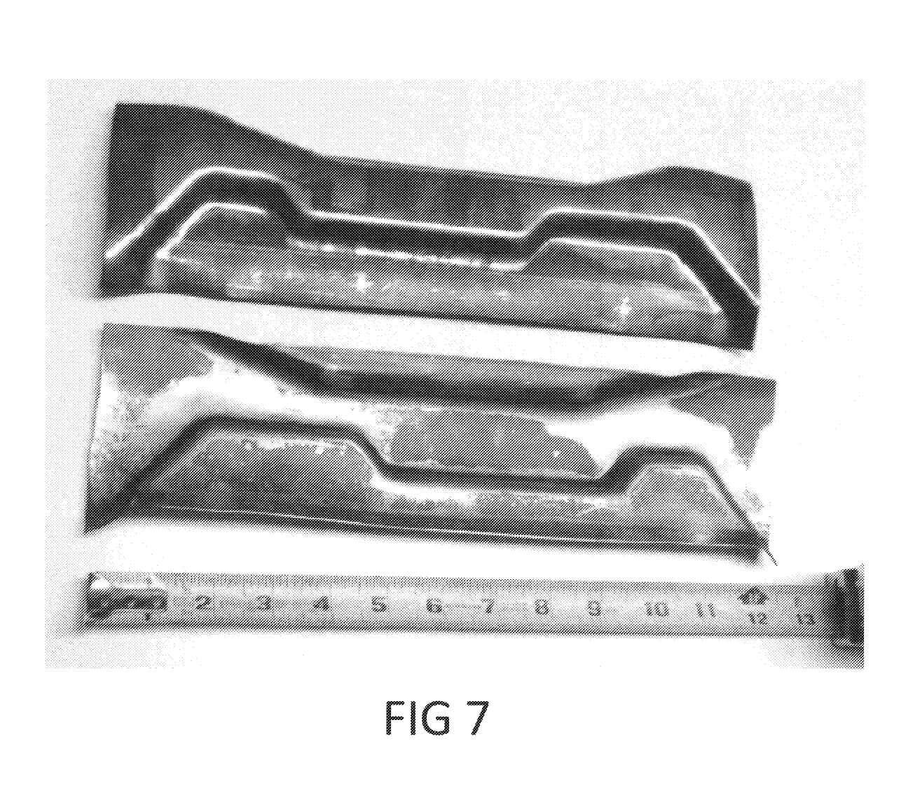

FIG. 7 shows another example of a 1550 megapascal cold stamped plain carbon steel component manufactured of Flash® Processed sheet with the present invention. Notice again that the pieces do not exhibit failure points, but rather show crisp corners and full forming by cold stamping.

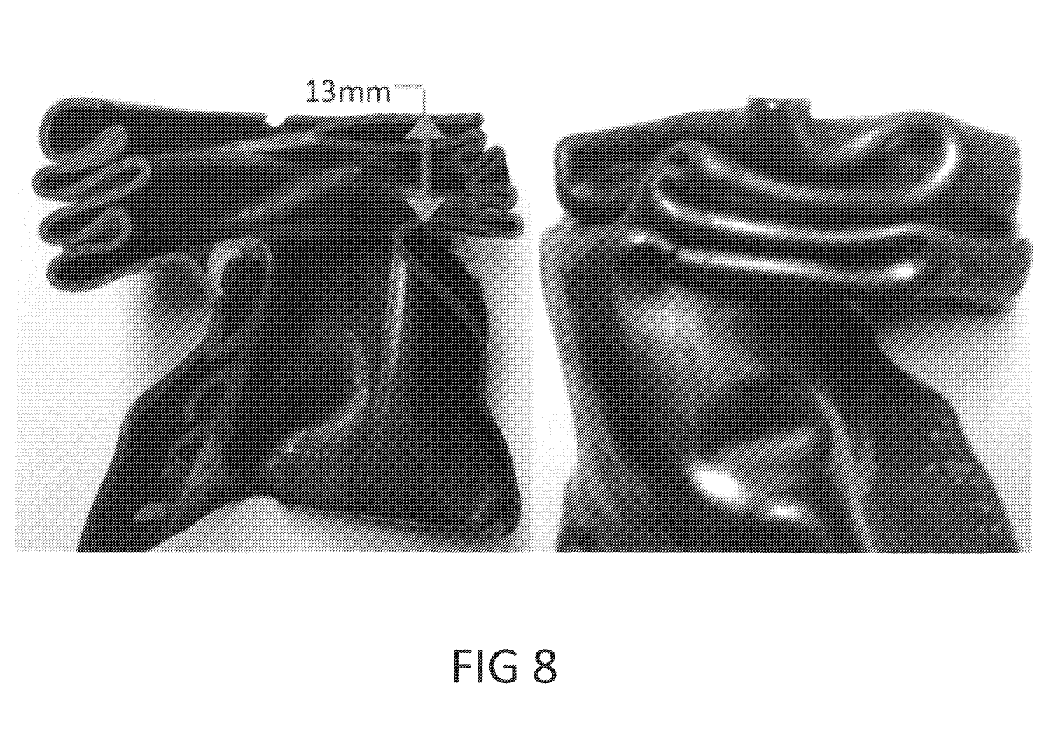

FIG. 8 illustrates the test results of a Flash® 1550 MPa test on an automotive part called a “Crush Can”. The inventor has found that parts made of Flash® at 1550 MPa with only 6% elongation can now be formed like folded over pieces of paper. This example shown here in FIG. 8 is one of these automotive “crush cans”. Crush cans are located between the vehicle's bumper reinforcement steel and the “frame rails” that extend outward fore and aft from the passenger compartment. As of today, it is widely accepted that steel denoted as DP780 (dual phase at 780 megapascals) is the strongest steel that can be used for crush cans without cracking. This is because DP780 is the strongest steel with historically acceptable ductility that could allow the steel to fold over on itself to a zero-T bend radius while absorbing energy during a crash event, essentially taking on the appearance of an accordion.

Two heats of Flash® processed AISI1020 were analyzed, one at 0.19% wt carbon/1.2 mm thick sheet steel and the other at 0.21% wt carbon/1.3 mm thick sheet steel. The former was formed into a 50×60 mm crush can, while the latter was formed into a 45×50 mm crush can. Both crush cans started at 140 mm tall but were collapsed in a stamping press set to height of 50 mm. Both variants of the crush can folded over to a 0T bend radius during the mechanically induced collapse.

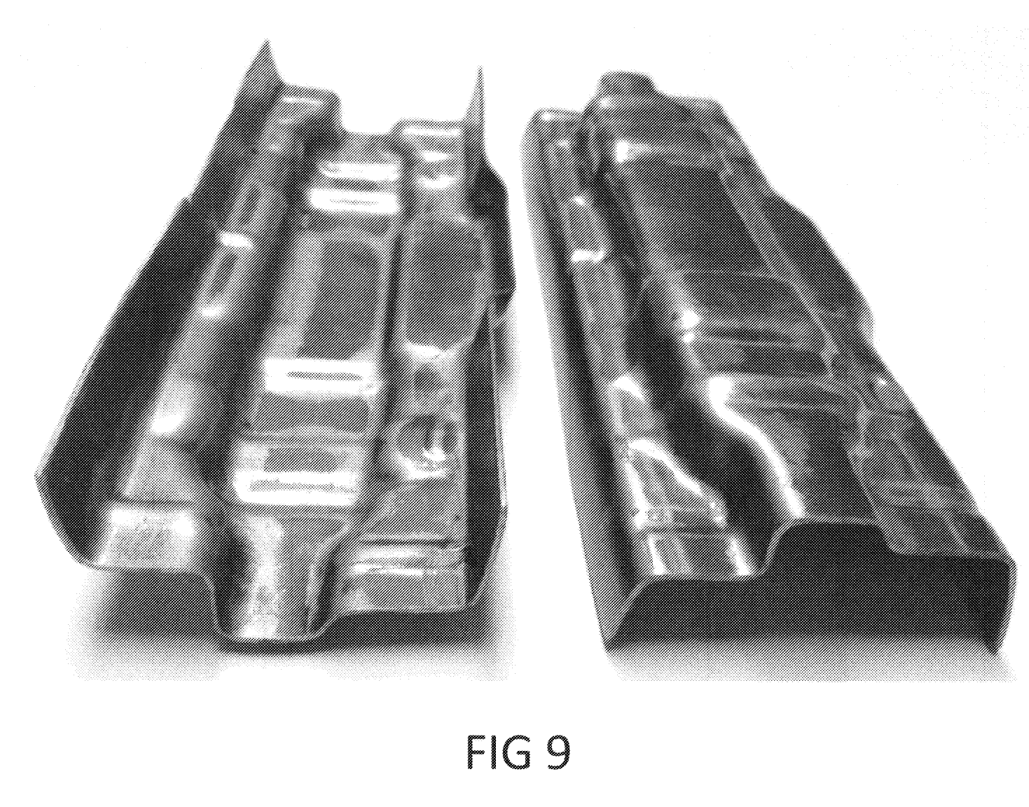

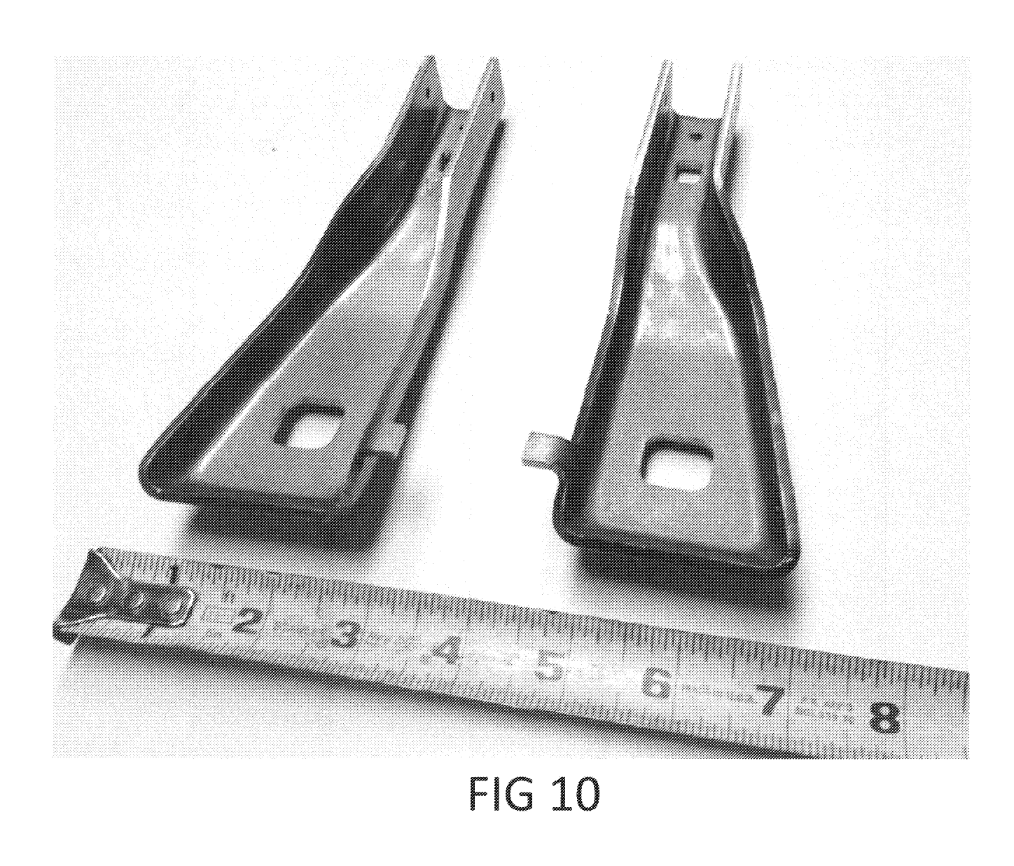

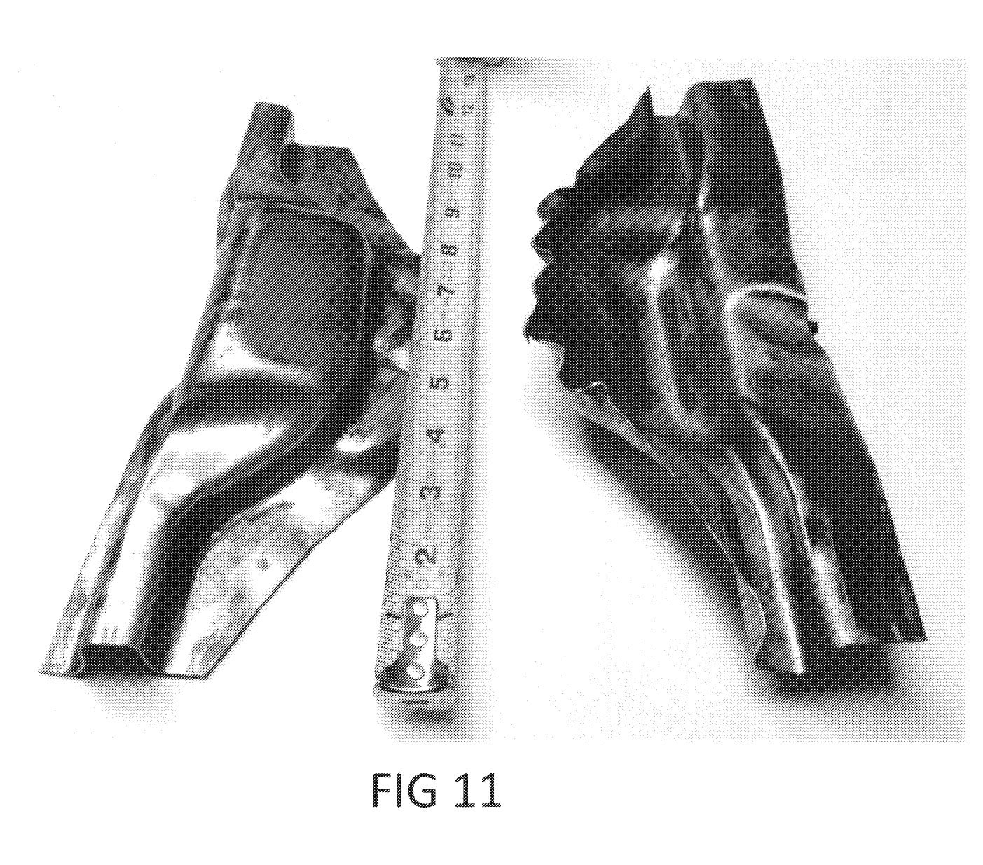

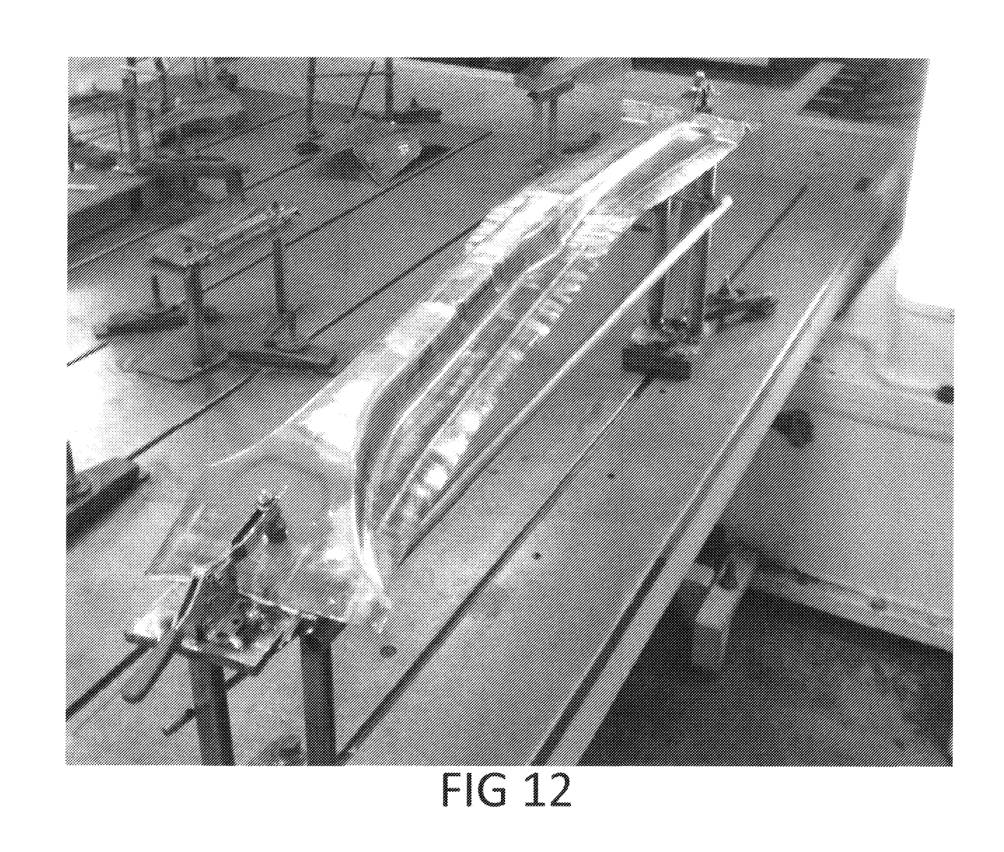

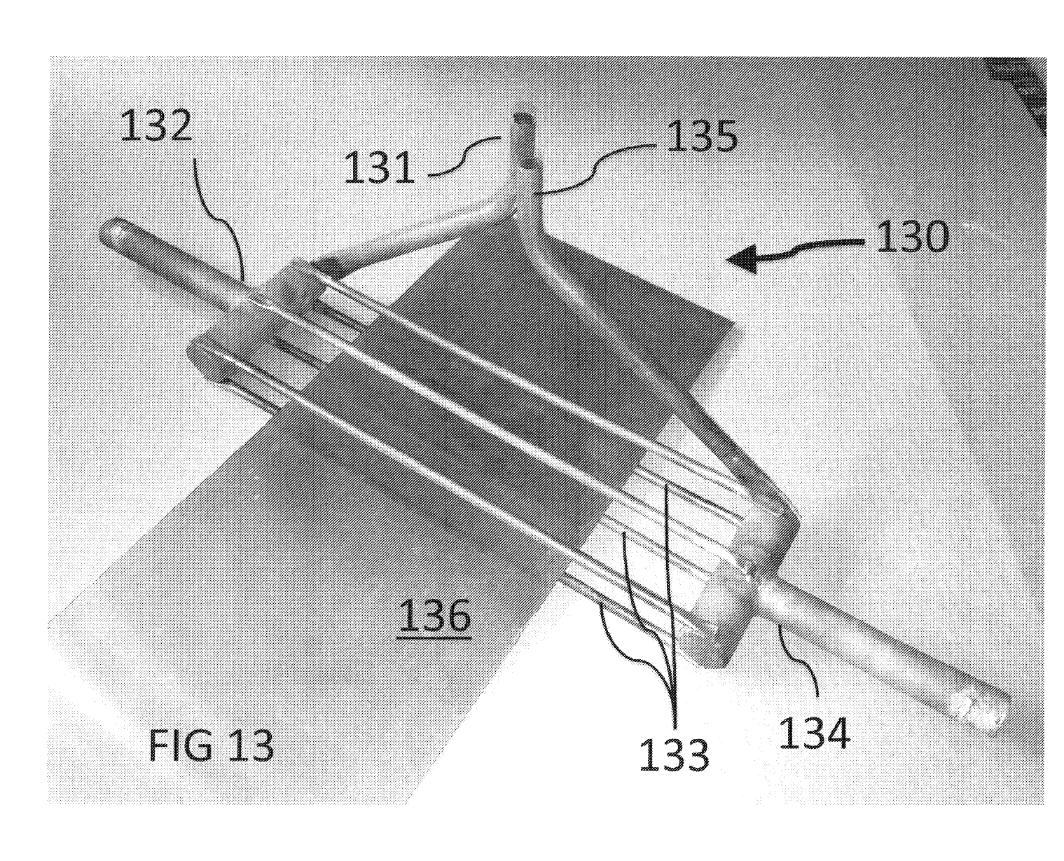

With combined reference to FIGS. 9, 10, 11 and 12, cold stamped parts are shown. After the initial Crush Can work was completed, the shown parts were four of the seven stamping press tools of increasing difficulty that were developed to test the formability of 1.2 mm thick Flash® Processed AISI1020 steel sheet. In each case, the Flash® Processed AISI1020 was able to be stamped into geometries with minimal bend radii less than two-T that would be conventionally thought impossible for a steel with only 6 to 6.5% elongation. As one can see, there were no apparent failure points anywhere on the parts.

FIG. 13 illustrates a mock-up of an induction heating coil in accordance with the process of the present invention. Power from a transformer may be initially connected at 131. Electrical current is evenly distributed over the outside surface of legs 133, and optional water cooling may be applied at 132 and would run through legs 133 to outlet 134. This particular mock-up of induction coil design illustrates six legs 133, running in parallel with respect to each other, and perpendicular with respect to steel strip 136 that will be heated as it passes through the induction coil 130. In this mock-up, both electrical and water current flow is uni-directional within induction coil 130, flowing from 132 to 134, illustrating a novel concept for induction heating. The novelty is because electrical current flows through induction coil 130 in a unidirectional mode, only transverse surrounding steel strip 136 in the shortest longitudinal length and time in order to achieve high power density in a magnetic field which will be created by the electrical current flowing therethrough. Optional cooling water exits at 134 while electrical current converges after running through legs 133 into outlet 134. At opposite connection to transformer 135, electrical current leaves induction coil 130, and returns back to an induction transformer. Three legs 133 are shown on each side of steel strip 136 that would be heated by electrical current passing through the three legs 133 on each side of the steel strip 136.

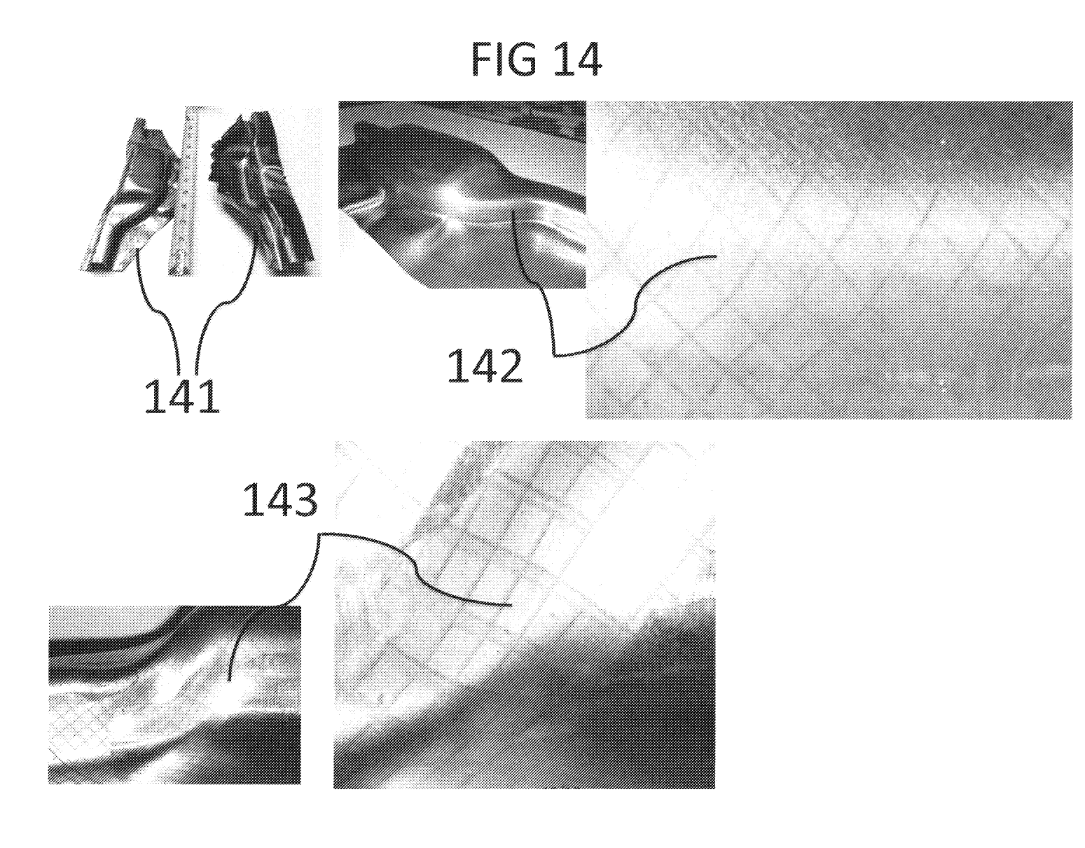

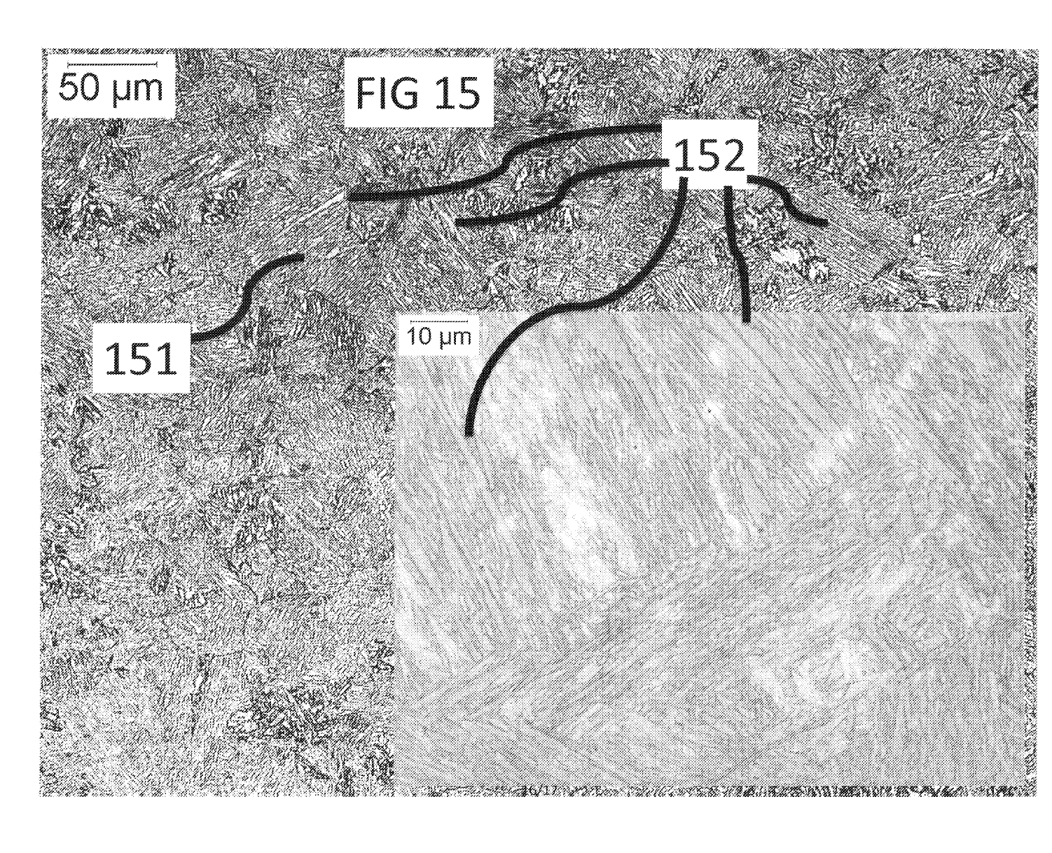

FIG. 14 shows cold stamped parts of Flash® processed materials, made from AISI0120 steel at a strength of 1550 MPa. Stamping of flat blanks of steel that were etched with a grid pattern prior to stamping best exemplify the unusual bend-ability of Flash® Processed steel from AISI10##. Workpiece 141 shows the top and inverse view of such a piece of approximately 30 cm. long. Workpiece 141 includes the etched square grid marking with its new elongated shape, indicating stretching and bending in multiple directions. Shown at a different angle of workpiece 141, this same workpiece is designated as 142, showing its new elongated diamond shape from its previously square grid marking that occurs after forming of the part. Close up view 143 shows how the square grid marked portion of the workpiece 141 has been stretched during forming operations to become a rectangle, where the length now equals about twice the width. FIG. 15 is a photomicrograph of enlarged prior austenite grains of Flash® Processed steel exceeding 50 microns in size. These individual grains are divided into segregated regions during quenching by the early transformation at elevated temperatures of low carbon microstructure in chemically lean low carbon regions, such as greater than 99% wt of iron in the alloy. In AISI4130 steel, this early transformation occurs from 650° C. to 550° C. during cooling. These segregated and refined regions which have the first austenite transformation's phase act as a pseudo grain boundary, which is then transformed at lower temperatures, at cooling from 460° C. down to 360° C., based on their chemistry. While the overall grain size may exceed 50 microns, the segregated regions may be less than 2 microns in a relatively flat configuration, like a series of relatively flat pancakes stacked one on the other, whether truly flat or slightly curled convex or concave shapes. These individual relatively flattened shapes may even constrain the secondary microstructural conversion to a nanometer scale.

In another aspect of the present invention, it may be advantageous to produce a precursor material prior to Flash® processing in order to achieve maximum results for the iron based alloy being Flash® processed. By spheroidize annealing a precursor iron alloy for Flash® processing, carbon and manganese content in the iron based alloy will migrate to the grain boundary precipitated austenite during the thermal cycling above and below the lower critical austenization temperature. The goal of spheroidize annealing of iron based alloy is to create carbides from any pre-existing pearlitic microstructure areas within the precursor material. Furthermore, spheroidizing will soften the iron alloy. Spheroidized steel is typically known to be the softest, weakest, most ductile microstructure for a given alloy. It has been discovered that the spheroidization temperature of the steel during the spheroidization annealing process needs to be carefully controlled and monitored to develop the proper microstructure for corrosion resistance, retained austenite, and/or Flash® Processing.

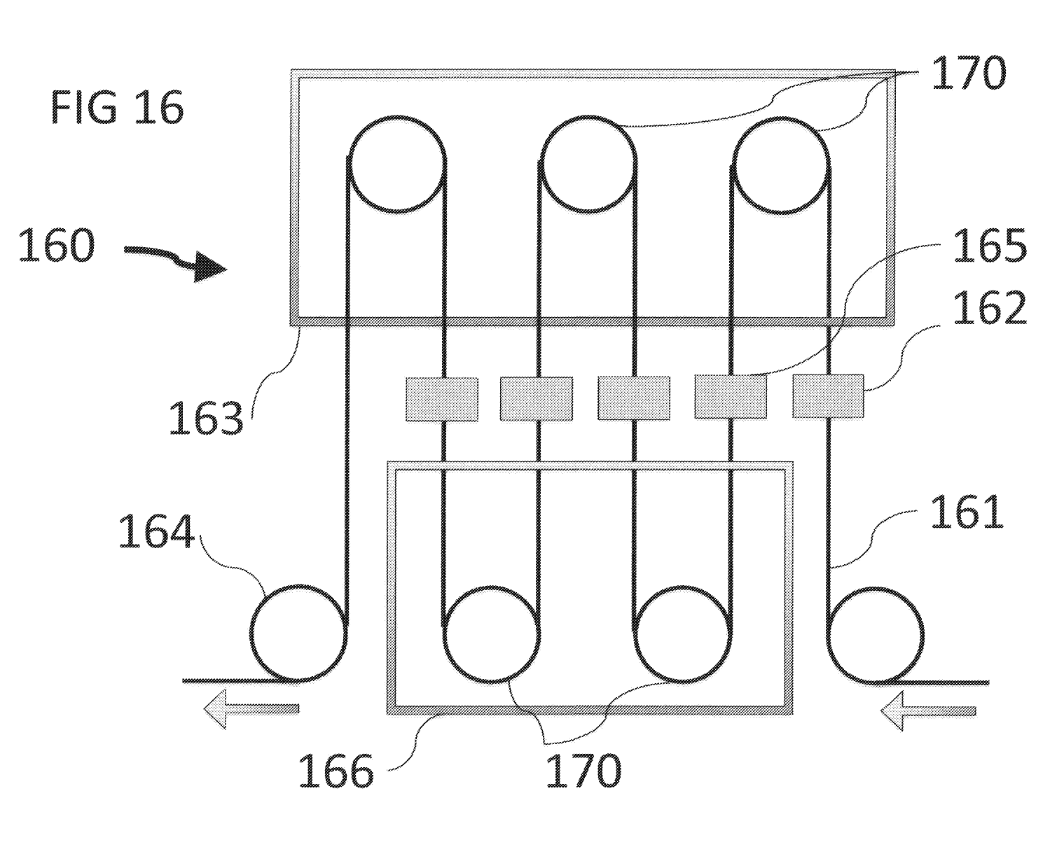

FIG. 16 is a depiction of a suitable spheroidize annealing line of continuous rolling equipment generally denoted by the numeral 160 that uses induction heating in this example to spheroidize anneal iron based alloys in less than an hour, preferably on the order of minutes. In this example, an iron alloy sheet 161 enters a multiplicity of rollers 170 shown from the right side of the equipment. A first induction heater 162 heats the steel no more than 35° C. above the lower critical austenization temperature of the iron alloy steel being employed, and the austenitizing temperature is dependent upon the iron alloy composition utilized. Iron alloy sheet 161 then cools down to at most 35° C. below the lower critical austenization temperature, again dependent upon the alloy utilized. Temperature is again optionally maintained in an insulated furnace 163 prior to entering the second induction heater 165, depicted in this illustration to the left of first induction heater 162, which again reheats the iron alloy sheet to above the lower critical austenization temperature, as described above. The iron alloy sheet 161 may then travel to an optional lower furnace 166 to maintain temperature if desired. The process may be repeated until iron alloy sheet 161 exits. Successive additional induction heating units may be utilized to heat iron alloy sheet 161 to the same temperature or its own discrete temperature, as desired. The furnaces 163 and 166 can be maintained at the same temperature or individual heating zones can be established to maintain a different temperature after rolling through each induction heating unit. While the equipment shown employs five induction heating locations, less or more heating locations may be desired for different iron alloys or prior microstructures. Other suitable methods of heating for this process may be advantageous, such as direct flame impingement, radiant, convective, conductive heating, as well as combinations thereof. Although not shown here, in accordance with the present invention, Flash® Processing equipment could also be employed in-line at the end of the spheroidize annealing line 160.

Oven furnace treatments taking up to 72 hours are typical for spheroidize annealing of steel coils to hold the temperature of the entirety of the steel coil just below the lower critical austenite conversion temperature. The lengthy thermal cycle is required for the temperature to equalize in the steel coil and allow pearlite to decompose to carbides to a prescribed volume fraction. For each alloy and furnace system, relatively similar but proprietary thermal cycles are commercially used for spheroidization.

This novel continuous feed rolling equipment being proposed here would feed a coil of iron alloy sheet through a multiplicity of induction heating coils to elevate the sheet's temperature multiple times to decompose its pearlite constituent similar to lengthy spheroidization cycles. Since the sheet of iron alloy is much thinner, using induction heating, for example, to locally heat the iron alloy above the lower critical austenization temperature could be accomplished in seconds instead of hours. When the sheet is heated in the first induction coil above the lower critical temperature, austenite would begin to precipitate at the grain boundary. As pearlite decomposes above the lower austenite temperature, and since austenite has a higher solubility than ferrite for both carbon and manganese, the precipitated grain boundary austenite enriches with both elements. Cycling below the lower critical austenite temperature when out of the induction heating coils' magnetic field effects, the enriched grain boundary precipitated austenite cools but maintains elemental heterogeneity. Each induction coil would be independently controlled to heat the iron alloy to a prescribed temperature above its lower critical austenization temperature while the steel not currently being induction heated would cool below the lower critical austenization temperature.

The rate of cooling could be controlled through the use of a thermally controlled insulated containment system containing rollers to transfer the steel sheet to prevent too rapid of cooling in ambient air for certain alloys. In other cases, depending on the thickness of the iron alloy and its residual heat content, ambient air cooling works well. While carbon migrates rapidly, it will take between 2 and 60 seconds above the lower austenization temperature to effect the decomposition of the pearlite, precipitation of austenite, and migration of carbon and manganese to the precipitated austenite grain boundary. As detailed above, the example of five cycles above and below the lower critical austenization temperature worked well to attain 30% retained austenite in the final product. Longer induction times, with more or less than five heat cycles can be used in combination with differing temperatures above the lower critical temperature but total time for the spheroidized annealing would be on the order of minutes, not hours nor days. Induction heating the iron alloy 1° C. to 35° C. above the lower critical austenization temperature and then allowing a cool off period via mechanical travel through an optionally insulated pinch roller system that allows the iron alloy to cool to 1° C. to 35° C. below the lower critical austenization temperature produces similar results to lengthy furnace treatments.

My issued U.S. Pat. No. 8,480,824, which is incorporated herein by reference, refers to an iron based alloy component. The method could be applied as well to a rolling strip of metal, such as steel, or other forms of iron based alloy. In accordance with the present invention, a new method of metal treatment is disclosed which results in transforming a low grade iron based alloy into an advanced high strength steel with extremely rapid heating of the metal followed by rapid quenching of the material without an intentional holding period to chemically homogenize the iron article. The resulting iron alloy is preferably a heterogeneous composition of at least two microstructures from the group of martensite, bainite, retained austenite, ferrite and the other microstructures discussed in more detail hereinbelow. Through spheroidize annealing and other prior heat treatments and chemistries, preferred prior microstructures are transformed to effect differing properties in the iron based alloy upon Flash® Processing.

Thus, it is a first aspect of the present invention to provide an inexpensive, quick and easy method to produce a low, medium, or high carbon iron-based alloy capable of being formed to minimal bend radii without the use of intense alloying or capitally intensive thermo-mechanical processes. While other thermo-mechanical processing techniques require lengthy thermal cycles to obtain a dual phase or complex microstructure typical of advanced high strength steels, Flash® Processing can do so with a single rapid heating and quenching operation which can take less than 20 seconds from below the lower austenitic temperature to a selected peak temperature and back down to below its martensitic finish temperature. Other longer duration methods explained herein can provide desirable metallurgical results provided that the first quenching step to below the bainitic transformation temperature occurs substantially immediately after reaching peak heating temperature.

It is a second aspect of the present invention to provide a method and apparatus for micro-treating low, medium, or high carbon iron-based alloys to contain a desirable quantity of Flash® processed complex microstructural material with heterogeneous chemistry bainite and/or martensite interspersed within the same prior austenitic grains. Creating a multiplicity of microstructures in a single prior austenite grain can be accomplished through chemical heterogeneity within the grain and the extremely rapid heating/rapid cooling cycle described herein. It is speculated that my heating to an unexpectedly and inordinately high temperature of Flash® Processing enlarges the iron alloy austenite grains to sizes of 5 to 50 microns or more which is counterintuitive to the steel industry's goal of grain refinement. However, it is believed that the rapid application of inordinately high temperatures provides the transformation driving force required to create low carbon bainite plates and/or martensite from the leanest alloy content portions of the iron alloy's individual austenite grain. It appears that bainite plates and/or low carbon martensite segregate the enlarged prior austenite grains into discrete, highly refined regions. During further cooling, after the transformation of the low carbon regions which occurs at higher temperatures, the remaining newly bounded refined regions with more carbon are part of secondary transformations to respective austenite daughter phases based on chemistry as defined by continuous cooling transformation curves, likely bainite and martensite. This prescribed method is a way to mimic grain refinement through counterintuitive grain expansion and subsequent segregation via microstructural phase division.

Such pseudo-grain refinement through prior austenite grain division is believed to enhance the mechanical properties of Flash® Processed iron-based alloys, including steel. Higher than expected strength and elongation as well as greatly increased bend-ability are believed to be a direct result of this highly refined “effective” grain size. This unexpectedly good result of high bend-ability to zero-T and one-T bending radii with Flash® Processed plain carbon AISI10## steel disassociates the terms of elongation, formability, and ductility. It appears that Flash® Processed AISI10## steels are capable of historically impossible acts of bending and forming in stamping press operations as what had been previously understood based on their Rockwell C hardness of 44 to 48.

It is now believed that the Flash® Processed microstructure of plain carbon, or lesser alloy content than required by plain carbon steel specifications, can be formed to extreme shapes, provided that the steel is not stretched or elongated past its traditional failure point as part of the forming operation. It is proposed that when describing Flash® Processed iron based alloys, that they be described with the terms strength, elongation, and formability or bendability. These factors identify this newly discovered unexpectedly good result. Flash® processed AISI10## steel thus possesses an unusual bend-ability factor. For example, a conventional “brake press” is used for forming traditional steel in a two dimensional mode to form a linear bending of the sheet about a given radius. Flash® Processed AISI10## steel is able to be bent along a non-linear axis of a stamping tool whose bending form could be defined mathematically as a B-spline. Stamping of flat blanks of steel that were etched with a grid pattern prior to stamping best exemplify the unusual bend-ability of Flash® Processed steel from AISI10##. These parts can be seen in FIG. 14, what was once a square grid pattern has been stretched and compressed to become a rectangle whose length is twice its width.

Yet another aspect of this invention results in a heterogeneous chemistry microstructure with a desirable volume percentage of retained austenite. This heterogeneous microstructure yields a high strength complex multi-phase microstructure suitable for advanced high strength steel applications. In making this steel, when in the liquid state in the melt ladle, the precursor steel alloys are homogeneous as austenite, a face centered cubic microstructure. As the steel is poured from the ladle and solidified, the microstructure changes. Some of the prior austenite grains will become ferrite or pearlite when cooled. In some cases, depending on alloying, carbides will precipitate. When an abundance of carbon, manganese, and/or nickel are present in the localized chemistry at the appropriate weight percent in a portion of a prior austenite grain, the microstructure will become what is called “retained austenite” at room temperature. Carbon in excess of 0.54% wt with 5% wt manganese is one such example, but many other combinations exist. The concentrations of the carbon and manganese can be readily calculated using Continuous Cooling Transformation theory. Those skilled in the art have well developed formulations for determining the percentages necessary of the austenite stabilizing elements such as carbon, manganese, and nickel, which tend to lower the eutectoid temperature of the steel. Retained austenite will lend to ductility and formability of the resulting steel. In addition to the ductility, the need for high strength in steels is well known. It is also conventional knowledge that ferrite is typically not desirable for strength. Unfortunately, this form of retained austenite is “blocky” consuming an appreciable volume fraction of the prior austenite grain if not the entirety, and surrounded by ferrite and pearlite. This blocky retained austenite, while desirable, could be improved upon to result in higher performance for the same iron alloy chemistry.

Control of initial microstructure can achieve a more desirable retained austenite novel microstructure that is an excellent precursor for Flash® Processing. It has been discovered that nominal amounts of carbon (0.05% to 0.45% wt) and manganese (0.2% to 5% by weight or more) can be manipulated to concentrate at the prior austenite grain boundary to enrich the region enough to precipitate austenite that is room temperature stable. This is accomplished by cycling the iron alloy below and above its lower critical austenization temperature. When above the lower critical temperature, austenite begins to precipitate at the grain boundary. As pearlite decomposes above the lower austenite temperature, and since austenite has a higher solubility than ferrite for both carbon and manganese, the precipitated grain boundary austenite enriches with both elements. Cycling below the lower critical austenite temperature, the enriched grain boundary precipitated austenite cools but maintains elemental heterogeneity. Repeating this process at least twice, additional carbon and manganese will continue to enrich the grain boundary region. Cycling an alloy with 0.3% weight carbon and 3.0% weight manganese five times above and below the lower critical austenite conversion temperature by 15° C. has created up to 30% volume fraction of retained austenite in the final product. While each iron alloy and elemental concentration is different, fewer or more than five cycles may provide the desired volume fraction of precipitated austenite. The remainder of the microstructure would be predominantly ferrite and pearlite when allowed to cool slowly to room temperature. Carbides will also form but size, shape, and quantity can be controlled by known transformation methods. The bulk weight percent of manganese present in the alloy chemistry, based on the total weight, will primarily determine the volume fraction of grain boundary precipitated austenite that stabilizes at room temperature due to its localized enrichment. It should be noted that simply holding the iron alloy above the lower critical austenite conversion temperature tends to create blocky retained austenite. More desired is the present method which creates a network of grain boundary austenite that is interconnected to another, appearing similar to a spider's web.

Upon Flash® Processing as described herein, this precursor microstructure of austenite, ferrite, pearlite, carbides, and minimally other austenite daughter phases will be converted to an advanced high strength steel. As previously described, since the duration of Flash® Processing above the lower austenite conversion temperature is so short, there is minimal time for homogenization to occur, thus the prior heterogeneous microstructure is preserved. During the thermal cycling of Flash® Processing, the grain boundary precipitated austenite will simply reheat and quench to retained austenite. Per continuous cooling transformation theory, if the elemental percentages were sufficient for precipitated austenite to exist at room temperature prior to Flash® Processing, then the same would be true after rapid Flash® Process cooling. The heterogeneous ferrite and pearlite would primarily become a mixture of bainite and martensite after Flash® Processing, based on their localized non-equalized chemistry. When carbides dissolve during Flash® Processing in regions where manganese and carbon enrichment was not sufficient to previously create precipitated austenite, it has been found that the introduction of this extra carbon from dissolving carbides can combine locally with the existing carbon and manganese to now create room temperature retained austenite. Localized creation of retained austenite by introduction of carbon caused by rapid carbide dissolution in a manganese enriched environment just prior to quenching is a novel aspect of this invention.

It has long been known that phosphorus can contribute to corrosion resistance of steel. In fact, some blacksmiths chose to work with iron-phosphorus steel in lieu of the now very common iron-carbon steel. The Iron Pillar of Delhi is one such example of an iron object that has existed for 1600 years without significant corrosion. Despite its age and exposure to weathering elements, only a 0.002″ thick layer of oxidation exists. Estimates of the phosphorus content of the Pillar range from 0.25% to 1.0% by weight. In direct contradistinction, modern steel making methods typically try to limit phosphorus to 0.002 to 0.004% wt. Even commercially available high phosphorus “re-phosphorized steels” only contain up to 0.16% wt phosphorus. Phosphorus is avoided in modern steel making methods to avoid phosphoric embrittlement of prior austenite grain boundaries that occurs during part forming operations in stamping presses and the usage of such parts. Known as “cold shortness”, phosphorus is well documented to reduce the uniaxial elongation significantly by up to ⅓ in many steels. Such a reduction could easily cause the steel part to crack during forming in stamping press operations or roll forming. An object such as the ornamental Delhi Pillar is not subjected to the operational stresses of an automotive structural component. However, because the Iron Pillar of Delhi is not under any load, the elevated phosphorus content is not detrimental to the function of the Pillar. Rather, for industrial applications when the steel would be put under load, it would mechanically fail. Flash® processing is ideal for maintaining high phosphorus content in the grain interiors, thereby providing corrosion resistance without exhibiting embrittlement.

Phosphorus is known to migrate slowly as a solid solution strengthener in a body centered cubic microstructure of ferrite. As such, ferrite can maintain a phosphorus concentration of 0.35% wt at an elevated temperature, but exhibits a near zero concentration at room temperature. Face centered cubic austenite can maintain a phosphorus concentration of only 0.28% wt. It is well known that during typical heat treating operations with lengthy austenization cycles held above the lower austenization temperature, ample time exists for phosphorus to migrate to grain boundaries, and thereby embrittling the steel. Again, for corrosion resistance, the phosphorus needs to stay in the grain interior, not migrate out to the grain boundaries. Conventionally, such lengthy austenization cycles have been employed by the steel industry to obtain quench and tempered advanced high strength steels. Knowing this, phosphorus has always been limited to a minimum concentration, preferably less than 0.04% wt, in order to avoid the aforementioned grain boundary embrittlement, despite the corrosion resistant benefits that could be had.

A method is proposed here to yield a corrosion resistant, high phosphorus, iron based alloy which may be used in the condition created by the annealing method described herein or heat treated into an advanced high strength steel by Flash® Processing. Recognizing the relative rapidity of phosphorus migration, any time the iron based alloy spends above its austenization temperatures must be limited to maintain relatively higher concentrations of phosphorus in the prior austenite grain interior. Through methods aforementioned in this application where the iron based alloy is quenched immediately to temperatures below the austenitizing temperature, time spent by the alloy above austenization temperatures can be minimized to prevent phosphorus migration. In practicing this invention, concentrations of phosphorus may be much higher than previously known in the steel industry, from 0.1% to about 2% wt, based on total weight of the alloy. More preferably, the phosphorus content will be from 0.2 to 1.0% wt, such that the phosphorus concentration will create a corrosion resistant steel. The corrosion resistance is achieved by a method similar to passivation of stainless steels. An apparent but very thin layer of iron hydrogen phosphate crystallization forms on the steel due to the high phosphorus content.

As described in the methods above to spheroidize anneal a precursor iron alloy for Flash® Processing, the carbon and manganese migrate to the grain boundary precipitated austenite during the thermal cycling above and below the lower critical austenization temperature. Simultaneously, the phosphorus will migrate to the grain interior since phosphorus prefers to avoid co-location with carbon. The grain interior, composed primarily of ferrite and undissolved pearlite, will become enriched with phosphorus. As stated above, the bulk iron alloy weight percent of manganese, based on the total weight, will determine the volume fraction of precipitated austenite that stabilizes at room temperature. In corrosion resistant steel, for uses such as architectural sections, lesser manganese would be added to the bulk chemistry as retained austenite often would not be desired for strength in architectural sections. In this case, the grain boundary would be enriched primarily with carbon but also the minimal manganese present in the bulk chemistry. Conversely, for formed articles in the automotive industry, higher weight percentages of manganese may also be employed as beneficial to create a corrosion resistant retained austenite containing iron alloy. Whether manganese is present or not, phosphorus would remain primarily in the grain center to effect corrosion resistance without grain boundary embrittlement.

When the present method to create a precipitated austenite microstructure is practiced in combination with the addition of the phosphorus in the matrix, a superior result is achieved in that the corrosion resistance is greatly increased. By providing an increased concentration of phosphorus, and coupling that with the substantially immediately quenching step, the phosphorus concentration is “frozen” into the grain interior, which means that the phosphorus atoms did not have enough time to migrate into the grain boundary region of the material. Therefore, a surface effect appears to result where a corrosion resistant layer is formed on the surface of the steel.

If the surface is scratched, corrosion resistance is maintained. The newly exposed iron alloy exhibits a bulk effect because the high phosphorus content is throughout the entire material. Upon scratching the surface, the newly exposed surface develops a thin layer of corrosion resistant iron hydrogen phosphate to match the unscratched areas of the article. Furthermore, addition of copper to the steel has been found to increase ductility and machineability while also enhancing the corrosion resisting effects of phosphorus. While an upper limit on copper concentration is not bounded, typically lesser amounts, such as 0.1 wt % to 1.0 wt %, and preferably 0.3% wt copper tends to assist the phosphoric effects. When combining this matrix additive to the method being practiced, an even more superior material results.

As all alloying elements in steel affect the harden-ability, strength, and ductility, a balance is achieved through the use of carbon, manganese, phosphorus, copper, and other common alloying elements to optimize the most desirable properties.

In direct contradistinction to existing steel industry methods, my new high phosphorus inclusion achieves an unexpectedly good result by intentionally including unusually high weight percent of phosphorus in steel alloys, based on the total weight, with similar alloy constituent concentrations to those of the minimally cold worked steel products. While it is likely that the prior art compositions prefer to limit phosphorus to 0.04% or less, my intentional addition of much higher amounts, such as 0.10% to 1.0% weight of phosphorus, based on the total weight, have shown us that it can be beneficial for this aspect of my novel steel chemistry product based on heterogeneity at the grain level.

Following these aspects of the present invention, a desirable outcome of spheroidizing the Flash® precursor alloy is to heterogenericize any iron based alloy, such as steel, to a specific grain design. This can be done by heating the alloy or steel up to nearly the lower austenization temperature, or cycling to just above, to create what is known as precipitated austenite. It is well known that austenite precipitates near the perimeter of the grain boundaries leaving ferrite in the center of the steel grain. It is also well known that carbon and manganese will enrich the austenite portion of the steel grain while mostly depleting the central ferrite portion of the steel grain. Additionally, by the nature of the spheroidizing process, carbides will be formed in the areas enriched with carbon, i.e. the austenitic perimeter.

Upon Flash® Processing, this desirable precursor alloy microstructure creates a novel martensitic grain central region, optionally phosphorus enriched, surrounded by a partially retained austenite, martensite and/or bainite region at the perimeter of the grain. The retained austenite in the perimeter will be caused by a combination of the manganese enrichment in the presence of carbon. Another novel aspect of this invention is that some of the retained austenite is actually the prior precipitated austenite from the precursor material creation that was simply Flash® Process heated, and then quenched down in temperature to become what is considered retained austenite.

Typical Continuous Cooling Transformation (CCT) diagrams, well known to those skilled in the art, define the composition of carbon and manganese required to stabilize retained austenite. The carbon in the perimeter stabilizes the newly formed retained austenite by either the previously discussed migration from the central grain region during precursor processing, minimal carbon migration during Flash® Processing, or from the dissolution of carbides in the perimeter region. It is possible that some retained austenite will be formed in the central grain region due to carbides that might be present in the predominantly phosphorus rich central ferritic region.

An example of interrupted cooling during the Flash® Process cycle could occur below the bainite finish temperature of the iron alloy. After the bainite is formed, a localized austenite grain chemistry of 0.01% wt carbon and 5% wt. manganese with a martensitic start temperature of approx 345° C. could exist. The quenching could occur substantially immediately in a molten salt bath which may or may not be agitated. The salt bath should be minimally aqueous/liquefied and be at a temperature that is at least higher than the martensitic start temperature of 345° C. as provided for in this example. At a quench temperature above 345° C., nearly all of the freshly formed austenite will remain untransformed into new austenite daughter phases.

Experiments have shown that in most cases, in order for zinc to be able to galvanize this iron based alloy, we get better results if we do not quench all at once, otherwise the zinc will not stick to the surface of the steel. Best galvanizing results come when we first quench down to just above the martensitic start temperature, transforming the low carbon chemistry regions, so the zinc will stick. The purpose of quenching to just above the martensitic start temperature of the prior ferrite would be to reduce the temperature of the steel from above the austenitic temperatures down to a point at which carbon migration, carbide dissolution, and alloy homogenization slows dramatically. While slowing these three actions to less than the carbon migration rates during austenization, remaining above the martensitic start temperature would not allow transformation to austenite daughter phases to occur. Such a temperature reduction from above the austenization temperature, to between above the martensitic start temperature to near 460° C., known as the temperature of galvanizing zinc baths, is required for proper adhesion of the zinc coating to the steel. The steel would then be appropriately cleaned of impurities, without going below the martensitic start temperature, and then taken through a bath of molten zinc for the purpose of galvanizing the steel. If proper molten salts are used, the steel will exit the salt pot clean enough to go straight into the galvanizing bath.

Upon leaving the galvanizing bath, the steel would be cooled to room temperature. Various quenching methods may include: first, either directly to room temperature; second, cooling to use CCT to make a prescribed percentage of bainite from the non-transformed austenite; third, cooling to use CCT to make a prescribed percentage of martensite from the non-transformed austenite. Subsequent tempering is optional.

While the leanest alloyed Flash® Processed AISI10## steels appear to be able to be bent to minimal forming radii such as zero-T and one-T, it should be considered that an addition of very minimal alloying is still considered part of this invention. As such, it would not be appropriate to include negligible amounts of other alloying elements to achieve essentially the same unexpectedly good result and claim the addition of such non-effective alloys as a new invention.

Yet another aspect of the Flash® invention relates to the induction heating coils that can be used to heat the steel article. Induction heating is typically defined by the direction of the induced magnetic flux from the coil. The most common is longitudinal flux induction. The lesser known and used is transverse flux induction.

In longitudinal flux induction heating, the frequency of the induction unit is of extreme importance. Typically the induction heating coils will wrap around (or encircle) the part to be heated. For example, upon leaving one pole of the induction transformer, the heating coil inductor will be constructed to span transverse across the top of the sheet of steel, bridge to the opposite side of the sheet of steel, return across the bottom (or opposite) side, and attach to the other polarity pole of the induction transformer. In such a scenario, the current flow in the two legs of the induction coil have an opposed directional flow with respect to the article being heated while completing the electrical circuit as current runs through the coil. This opposed current flow may cancel the magnetic field created by the induction coil reducing its ability to heat the steel. The penetration depth into the steel part is determined by the frequency. Low frequency units such as 1 to 10 kilohertz are typically used to heat sections from 1″ to ⅜″ thick respectively. Higher frequency units of 100 kHz to 400 kHz are used to heat thinner sections such as 1/16″ to 1/64″ thick respectively. Cancellation effects occur in the varying thicknesses of heated components such that proper frequency must be selected for the most efficient heating of the component. Using too low a frequency in a thinner workpiece will result in cancellation effects that will prevent the part from heating to desired temperature. Precise frequency varies per application but is easily determined with the use of commercially available software programs and are well known to those skilled in the art. It is well recognized that for a given power level, measured in kilowatts, higher frequency units can cost double the price of the lower frequency units.

Transverse flux induction heating methods are well know to heat thinner walled work pieces, especially sheet steels. Lower frequency induction units have the benefit of being lower cost. However, typical transverse flux configurations are limited in effectiveness, power density, and their ability to heat iron based alloys at rates required for the present invention based on their geometric configuration. While longitudinal flux heating coils typically wrap around the work piece and heat from both sides with electrical currents flowing in opposed directions, transverse flux induction heating coils tend to function on a single side of the workpiece. In a typical transverse flux coil, upon leaving one electrical pole of the induction transformer, its copper inductor and its electrical current flow would travel transverse across the sheet, bridge longitudinally up along the length of the strip, move back transverse across the sheet, and then return back down to the point of origin to connect to the other transformer electrical pole. Generally, two parallel copper inductor legs of the coil heating run transverse across the steel and must be separated along the length of the steel strip to prevent their opposing current flows from cancelling their magnetic fields on the same side of the steel due to them acting with opposing forces on the steel strip. In some instances, a pair of transverse coils can be applied simultaneously to both sides of the steel sheet. Similarly located parallel legs of each pair of coils have current flow in the same direction, thus providing an effective method of heating without cancellation effects. In this scenario, the sheet of steel is a plane of symmetry between the two coils. However, in both cases, the necessity to separate the transverse copper inductor legs of the coil with current flowing in opposite directions increases the overall effective longitudinal distance along the sheet, reduces the coil's effective power density, and increases the overall duration of time that the steel is heated above the austenization temperature. After decades of research, transverse flux induction is well known to those skilled in the art but used sparingly.

A new development in transverse flux induction heating coils has proven highly effective in heating thin sheet metal rapidly in a short distance and timeframe with a high power density. In this novel design of transverse flux magnetic field application, all current flow in the coil's copper legs affecting the steel strip runs in the same direction across the steel strip. There is not a longitudinal separation needed along the length of the iron alloy sheet required in this transverse flux induction heating since no cancellation effects are occurring. To accomplish this, the electrical circuit created by the copper pole of the inductor of the induction heating coil is divided across multiple legs with the current from all legs flowing in the same direction across the sheet. The induction heating coil is constructed from the transformer at one pole. A larger cross section leg is initially used, for example, a ¾″ square inch copper tube. Upon nearing the steel strip, the ¾″ square tube branches into multiple ⅜″ square tubes which run transverse across the steel strip. Typically, at least one ⅜″ square tube must run parallel to another ⅜″ tube on opposite sides of the steel strip, but it is possible for all parallel branches to reside on just one side of the steel strip. Additional ⅜″ square tube inductor legs may be divided from the main ¾″ square tube to run on either side of the steel strip. Branching a single ¾″ square tube into six ⅜″ square inductor tubes of which three run parallel on each side of the steel strip works effectively to impart heat to the strip. It is possible by using different geometry tubes for both the initial piece and branches to have many possible combinations of branches running on opposite sides of the steel strip. For example, another design could be three copper induction branches on one side of the strip with seven on the other side of the steel strip. Even a scenario with twenty branches on one side and one hundred branches on the other side of the steel strip is possible. While maintaining power density and heating rate, more branches over a greater distance would be typically used in situations where longitudinal feed rates are higher than those slower rates of lesser branches. This is because the time required to Flash® Process must remain minimal to prevent carbon homogenization and carbide dissolution. In all cases, regardless of the number of branches running on both sides of the steel strip, the branches join together again once past the steel strip and again mechanically connect to ultimately attach to the other electrical pole of the transformer.

By having all current flow in the same direction along the tubular branches of the induction heating coil, the branches can be placed in close proximity to each other without the negating effects of cancellation occurring that are typical to a current flow system that has current running in opposed directions. Single direction current flow through the copper tubing effecting the steel strip is novel compared to the opposed current flow across the strip of typical traditional transverse flux induction heating.

In thin strips of steel, traditional induction heating causes a well known occurrence of cross-width waviness that develops as the steel is heated. This likely occurs as the microstructure of the steel changes from body centered cubic to face centered cubic typical of austenite. This volumetric expansion is often cited as being approximately 4%. While the steel strip may become 4% thicker locally, the expansion across the width of the strip of 4% is more difficult to manage. In steel strips that have been Flash® austenized within several seconds, strips thicker than 1.8 mm tend to expand controllably outward, longitudinally, and through the thickness thus maintaining relative flatness while heated. However, in steel strips of 1.2 mm thick, the cross width expansion pressure forces cause localized transverse waviness and deformation. Steel at 1.5 mm thick appears transitional with transverse waviness possible but not to the magnitude of 1.2 mm thick strip's waviness. Testing has shown, for example, that a 1.2 mm thick by 600 mm sheet will have seven ripples or waves occurring across the width. Upon quenching, these ripples and waves take a permanent positional form in the steel strip. This waviness is undesirable in the quest for flat steel sheet.

To remedy the cross-width waviness of the steel strip that occurs during rapid Flash® heating, mechanical straighteners and insulating straighteners are disclosed. It has been shown that the introduction of heat resistant ceramic constraints within the induction coil or just subsequent thereto can control the expansion of the steel strip. In one case, ceramic straighteners are placed in between and/or after the induction heating coil's copper inductors to contact the steel and simply not allow the waviness to occur. All cross width expansion is directed outward toward the edges of the strip without the steel strip rippling up mid-width. These ceramic insulating straighteners may take the form of rollers or individual mechanical resistance stops such as fingers, blades, or pads across the width of the strip. An additional method is to have a ceramic sleeve inserted inside the induction coil that has an opening that is slightly wider and thicker than the steel strip being austenitized. By having an opening thickness that is only approximately 0.1 mm to 0.2 mm thicker than the steel strip being austenized, there would be very limited space for the steel to ripple/wave. Alternately, the entire induction coil could be ceramic coated with a spacer the thickness of the steel strip, plus a minimal running clearance, held in place as a mold when the ceramic coating hardens. Upon hardening of the coating, the steel strip could be removed leaving a minimal clearance gap for the steel strip to be Flash® austenized to pass through. The running clearance of 0.1 mm to 0.2 mm is only an estimate based on experiences with Flash® processing at speeds of 400 mm per minute at a width of 600 mm. Upon scaling up to larger width and higher feed rates, it is likely that modifications will need to be made.

Another method to eliminate cross width waviness in the sheet is to use chilling rollers well known to those in the steel industry. The rollers could be constructed of copper and optionally water cooled through their center or by water spray to the exterior. The water cooling could be used to remove the heat from austenized iron based alloy and induce the transformation to austenite daughter phases. Additionally, water spray could be applied to the exiting faces of the iron sheet as it leaves the copper rollers to enact the transformation to austenite daughter phases.

It is a novel aspect of this invention that the carbon stabilizes the retained austenite by the rapid partial dissolution of carbides into the manganese enriched perimeter region during the rapid heating cycle of the Flash® Processing. All other known methods of creating retained austenite rely on either existing high carbon enrichment or migration of carbon during a partitioning process after the initial quenching has occurred. None of those conditions appear to be requisite when following the present invention. Therefore, a new microstructure is formed with a very desirable result without following old prior art compositions or methods.

Once Flash® Processed, the individual grains of the newly formed steel will possess novel properties. The optional phosphorus will cause a passivation layer to be formed that will be corrosion resistant. The retained austenite regions will be of value as a highly ductile strain hardening component. The combination of bainite and martensite will lead to what has been called “maximum strength steel” when the bainite to martensite ratio is 20-25% by volume. The presence of undissolved or partially dissolved carbides will be of value as a hard abrasion resistant component and also as a fracture interrupter to limit failure modes.

The foregoing description of a preferred aspect of the invention has been presented for purposes of illustration and description. It is not intended to be exhaustive or to limit the invention to the precise form disclosed. Obvious modifications or variations are possible in light of the above teachings with regards to the specific aspects. The aspect was chosen and described in order to best illustrate the principles of the invention and its practical applications to thereby enable one of ordinary skill in the art to best utilize the invention in various aspects and with various modifications as are suited to the particular use contemplated.

### INDUSTRIAL APPLICABILITY

The present invention finds applicability in the metal treatment industry and finds particular utility in steel treatment applications for the processing and manufacture of high strength steels in high volume processing.

1. A method to produce an advanced high strength steel in excess of 900 megapascals from plain carbon, or minimally alloyed steel which is capable of bend radii less of less than two material thickness.
